(19) United States
(12) Patent Application Publication
(10) Pub. No.: US 2025/0327287 A1
(43) Pub. Date: Oct. 23, 2025

(54) TOILET AND ASSOCIATED METHODS

(71) Applicant: MICHMAR DESIGNS INC., Windsor (CA)

(72) Inventor: Marc Lecours, Amherstburg (CA)

(21) Appl. No.: 18/953,186

(22) Filed: Nov. 20, 2024

Related U.S. Application Data
(60) Provisional application No. 63/637,502, filed on Apr. 23, 2024.

(51) Int. Cl. E03D 1/26; A47K 13/26; B29C 45/00; B29C 45/14; B29L 31/00; E03D 11/08

(52) U.S. Cl. CPC E03D 1/263; A47K 13/26; B29C 45/0017; B29C 45/006; B29C 45/14336; E03D 11/08; B29L 2031/7694

(57) ABSTRACT

This disclosure relates to toilets and associated methods. The toilet may include an upper portion secured to a lower portion. The toilet may incorporate a non-metallic material. A method of forming a toilet is also disclosed.

### CROSS-REFERENCE TO RELATED APPLICATION

The present application claims the benefit of U.S. Provisional Application No. 63/637,502, filed on Apr. 23, 2024, which is incorporated herein by reference in its entirety.

### BACKGROUND

This disclosure relates to toilets, which may be suitable for non-portable usage.

Toilets are known, and may include a tank secured to a lower bowl. The tank may convey water from a supply to the lower bowl. The lower bowl may convey waste to a sewage line. Some toilets may be made of porcelain, ceramic or stainless steel.

### SUMMARY

A toilet may include an upper portion including a tank and an upper bowl. The tank may include at least one port adapted to be fluidly coupled to a supply line. The toilet may include a trap. The toilet may include a lower portion secured to the upper portion. The lower portion may include a lower bowl. The lower portion may be overmolded on the trap. The trap may be adapted to interconnect the lower bowl and a discharge line. A flow path may be established through the tank, the lower bowl and the trap. At least one of the upper portion and the lower portion may be injection molded.

In any implementations, at least the tank of the upper portion may be formed of a plastic material. At least the lower bowl of the lower portion may be formed of a plastic material.

In any implementations, at least 75 percent of the materials of the toilet may be non-metallic excluding any fasteners, seals and components in the tank.

In any implementations, the lower portion may include a flow track. The flow track may include a channel that may extend at least partially about a periphery of the lower bowl.

In any implementations, the flow track may include a plurality of peripheral jets that may be distributed along a length of the channel. The peripheral jets may be dimensioned to deliver flow from the channel to the lower bowl.

In any implementations, the peripheral jets may be non-uniformly distributed along the length of the channel.

In any implementations, the channel may include an upstream section, and intermediate section and a downstream section. Each of the upstream, intermediate and downstream sections may include at least one of the peripheral jets. The intermediate section may have a relatively greater concentration of the peripheral jets than the upstream section and/or the downstream section.

In any implementations, the length of the channel may extend at least 90 percent about the periphery of the lower bowl.

In any implementations, the toilet may include a tank lid dimensioned to at least partially block access to a cavity of the tank. A living hinge may interconnect the tank lid and the tank.

In any implementations, the living hinge may include a first hinge portion established by the tank lid and a second hinge portion established by the tank.

In any implementations, the tank lid may include a raised periphery and a recessed area along a top of the tank lid. The raised periphery may bound the recessed area.

In any implementations, the toilet may include one or more mounting caps that may include a non-metallic material and may be adapted to mate with a respective fastener to secure the lower portion to a floor.

In any implementations, the toilet may include a toilet seat and a seat cover. The seat cover may include a fixation member that may establish a snap-fit connection with a mount of the toilet seat.

A method of forming a toilet may include forming a trap. The method may include injection molding a lower portion. The lower portion may include a lower bowl. The method may include injection molding an upper portion including a tank. The tank may be adapted to be fluidly coupled to a supply line. The method may include securing the upper portion and the lower portion to each other such that a flow path may be established through the upper portion, the lower portion and the trap. The trap may be adapted to interconnect the lower bowl and a discharge line.

In any implementations, the step of injection molding the lower portion may include overmolding the lower portion on the trap.

In any implementations, at least 75 percent of the materials of the toilet may be plastic excluding any fasteners, seals and components in the tank.

In any implementations, the securing step may include sonically welding the upper portion and the lower portion to each other.

In any implementations, the lower portion may include a flow track. The flow track may include a channel that may extend at least partially about a periphery of the lower bowl. The flow track may include a plurality of peripheral jets that may be distributed along a length of the channel. The peripheral jets may be dimensioned to deliver flow from the channel to the lower bowl.

In any implementations, the peripheral jets may be non-uniformly distributed along the length of the channel.

In any implementations, the step of injection molding the upper portion includes forming a first hinge portion. The method may include injection molding a tank lid, which may include forming a second hinge portion. The tank lid may be dimensioned to at least partially block access to a cavity of the tank. The method may include securing the first hinge portion and the second hinge portion to each other to establish a living hinge such that the tank lid and the tank may be connected to each other.

The present disclosure may include any one or more of the individual features disclosed above and/or below alone or in any combination thereof.

The various features and advantages of this disclosure will become apparent to those skilled in the art from the following detailed description. The drawings that accompany the detailed description can be briefly described as follows.

### BRIEF DESCRIPTION OF THE DRAWINGS

The embodiments will be better understood from the following detailed description with reference to the drawings, which are not necessarily drawn to scale and in which:

FIG. 1 discloses a perspective view of a toilet including an upper portion and a lower portion.

FIG. 2 discloses the toilet of FIG. 1 with a toilet seat omitted.

FIG. 3 discloses an exploded view of the toilet of FIG. 1.

FIG. 4 discloses components in a tank of the toilet.

FIG. 5 discloses a connection between the tank and a tank lid.

FIG. 6 discloses aspects of a toilet set.

FIG. 7 discloses the tank coupled to a supply.

FIG. 8 discloses an exploded view of the upper portion and the lower portion of FIG. 1.

FIG. 9 discloses assembly of components of the upper and lower portions of the toilet of FIG. 8 according to an implementation.

FIG. 10 discloses a perspective view of aspects of the upper portion of the toilet and a tank lid.

FIG. 11 discloses an isolated, perspective view of a trap of the toilet of FIG. 1.

FIG. 12 discloses an implementation of establishing the lower portion of the toilet.

FIG. 13 disclose a flow track and an associated flow path of the toilet according an implementation.

FIG. 14A discloses a sectional view of the toilet taken along line 14A-14A of FIG. 10.

FIG. 14B discloses a perspective view of a sectioned portion of the toilet of FIG. 14A.

FIG. 15 discloses aspects of the flow path of FIGS. 13 and 14A.

FIG. 16 discloses a view of the toilet taken along line 16-16 of FIG. 14A.

FIGS. 17-18 disclose the lower portion of the toilet and associated installation techniques according to an implementation.

FIG. 19 discloses a method of forming a toilet.

FIG. 20 discloses an exploded view of a toilet according to another implementation.

FIG. 21 is a perspective view of a portion of the toilet of FIG. 20 in an assembled configuration.

FIG. 22 is a perspective view of a portion of the toilet of FIG. 22 including a hinge connection.

Like reference numbers and designations in the various drawings indicate like elements.

### DETAILED DESCRIPTION

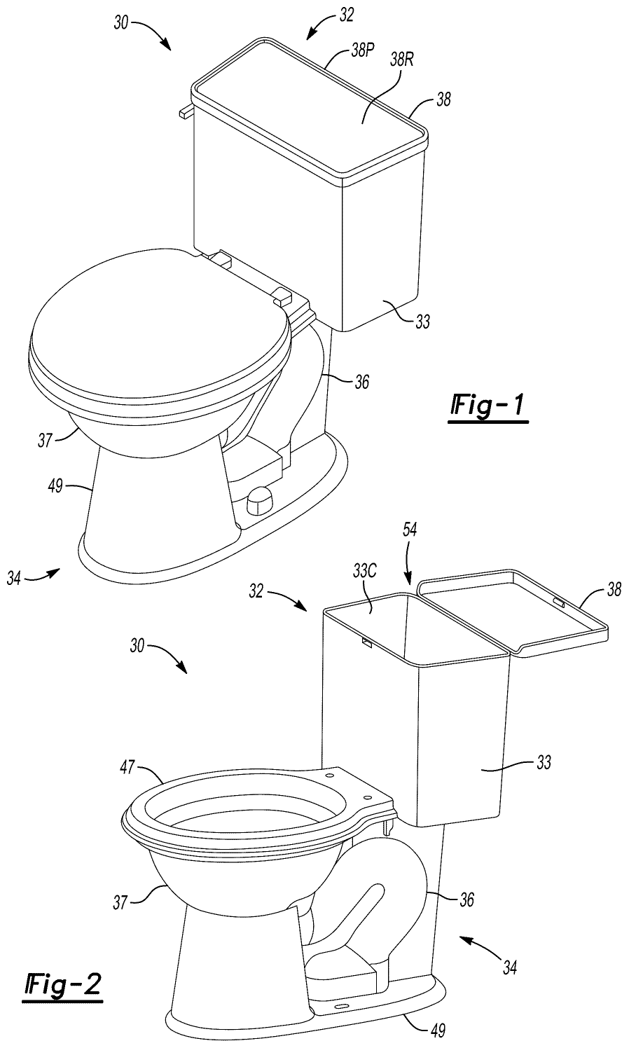

FIG. 1 discloses a toilet (e.g., unit or assembly) 30 according to an implementation. In implementations, the toilet 30 may be non-portable. The toilet 30 may be suitable for residential and/or commercial use. The toilet 30 may incorporate any of the materials disclosed herein, such as various plastic materials, and may be established utilizing any of the techniques disclosed herein. In implementations, the toilet 30 may include one or more injection molded components.

Referring to FIGS. 1-2, the toilet 30 may include an upper portion 32 and a lower portion 34. The upper and lower portions 32, 34 may be fixedly attached or otherwise secured to each other. The upper portion 32 may include a reservoir (e.g., tank) 33 and an upper bowl 47. The tank 33 and upper bowl 47 may be integrally formed or may be separate components fixedly attached or otherwise secured to each other.

The lower portion 34 may include a main (e.g., lower) bowl 37 and a base (e.g., support) 49. The base 49 may serve as a structural (e.g., weight bearing) support for the bowl 37 and/or upper portion 32 of the toilet 30. The lower bowl 37 and upper bowl 47 may be fixedly attached or otherwise secured to each other. The toilet 30 may include a trap 36 (e.g., gooseneck).

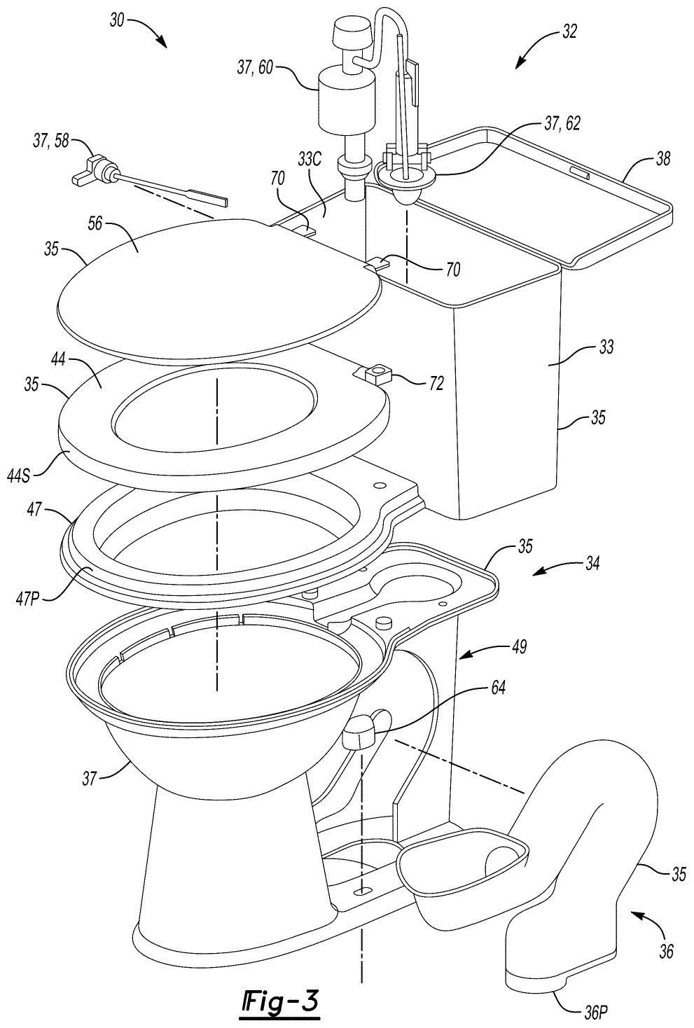

Referring to FIG. 3, with continuing reference to FIGS. 1-2, the toilet 30 may include one or more components 35, including any of the components disclosed herein. The components 35 may be integrally formed with each other and/or may be separate and distinct components. The components 35 may include the upper portion 32, lower portion 34 and/or trap 36. FIG. 8 discloses components 35 of the upper and lower portions 32, 34 of the toilet 30 with the trap 36 omitted. In the implementation of FIG. 3, the components 35 may include a toilet seat 44, a seat cover (e.g., lid) 56, a tank lid 38, and/or one or more mounting caps 64. FIG. 2 discloses a perspective view of the toilet 30 including the tank lid 38 in an open position and the toilet seat 44 and lid 56 omitted. The seat 44 and lid 56 may be a portion of a seat assembly including one or more fasteners to fixedly attach or otherwise secure the seat assembly to the upper bowl 47.

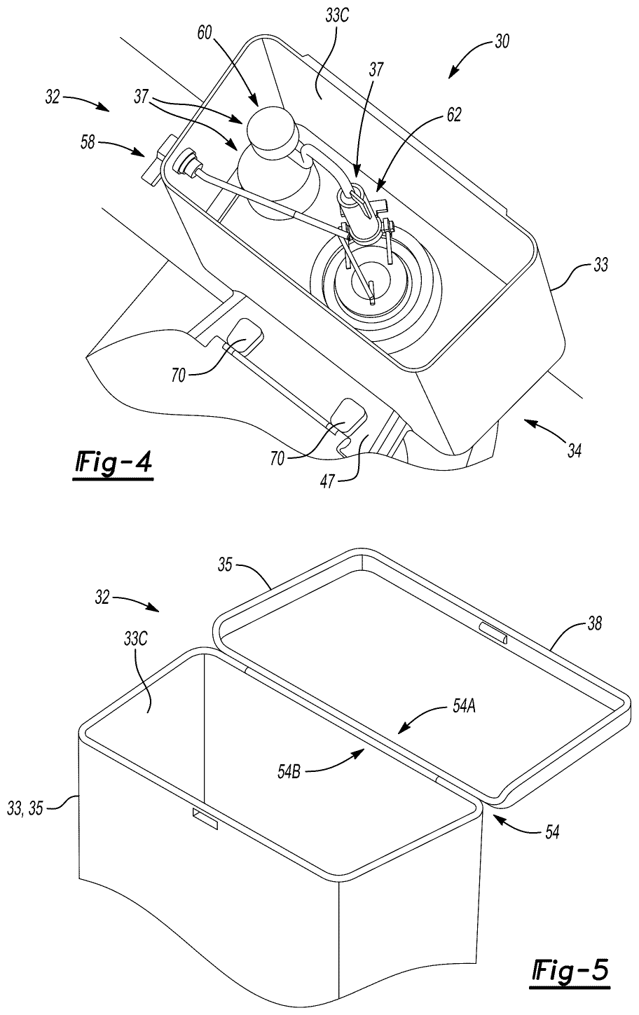

FIGS. 3-4 discloses various components 37 of the toilet 30. In implementations, the component(s) 37 may include one or more standard industry components. The components 37 may include a flush handle 58, a fill valve 60, and a flapper and fill tube 62. One or more of the components 37 may be situated in a cavity 33C of the tank 33. The components 37 may be assembled subsequent to forming the upper and/or lower portions 32, 34 of the toilet 30.

The components 35 of the toilet 30 may be formed utilizing various techniques, including any of the techniques disclosed herein. The component(s) 35 such as the upper portion 32 and/or lower portion 34, including the tank 33, lower bowl 37 and/or upper bowl 47, may be formed by any of the techniques disclosed herein, such as injection molding and/or an additive manufacturing technique (e.g., 3D printing). The upper portion 47 and/or lower portion 37 may be injection molded. In implementations, the seat 44, lid 56, tank lid 38, and/or mounting caps 64 may be formed by injection molding. One or more components 35 may be overmolded, including the trap 36.

The tank lid 38 may be secured to the tank 33 utilizing various techniques. In the implementation of FIG. 5, a (e.g., living) hinge 54 may be adapted to interconnect the tank lid 38 and tank 33. The hinge 54 may include a first hinge portion 54A established by the tank lid 38 and a second hinge portion 54B established by the tank 33. The first and second hinge portions 54A, 54B may interdigitate or otherwise mate with each other. The first and second hinge portions 54A, 54B may be injection molded or otherwise integrally formed with the respective tank lid 38 and tank 33. The tank lid 38 may be moveable between the open position and a closed position (e.g., FIG. 1). The tank lid 38 may be adapted to at least partially block access to the cavity 33C of the tank 33 when in the closed position. The living hinge 54 may establish a relative better condition for servicing the toilet 30. The tank lid 38 may prop itself up on a wall behind the toilet 30 (e.g., FIG. 13) and/or may be cantilevered from the tank 33 when in the open position.

In the implementation of FIG. 1, the tank lid 38 may include a recessed (e.g., containment) area 38R along an exterior (e.g., top) of the tank lid 38. The recessed area 38R may be bounded by a raised periphery (e.g., lip) 38P of the lid 38. The lip 38P may have a beveled geometry. In implementations, the recessed area 38R may have a depth of approximately 3/16 inch to ¼ inch or more. The recessed area 38R may be adapted to contain an amount of fluid, which may be useful to at least partially contain spilling of one or more articles positioned in the recessed area 38R. The recessed area 38R may be established during and/or subsequent to formation of the lid 38.

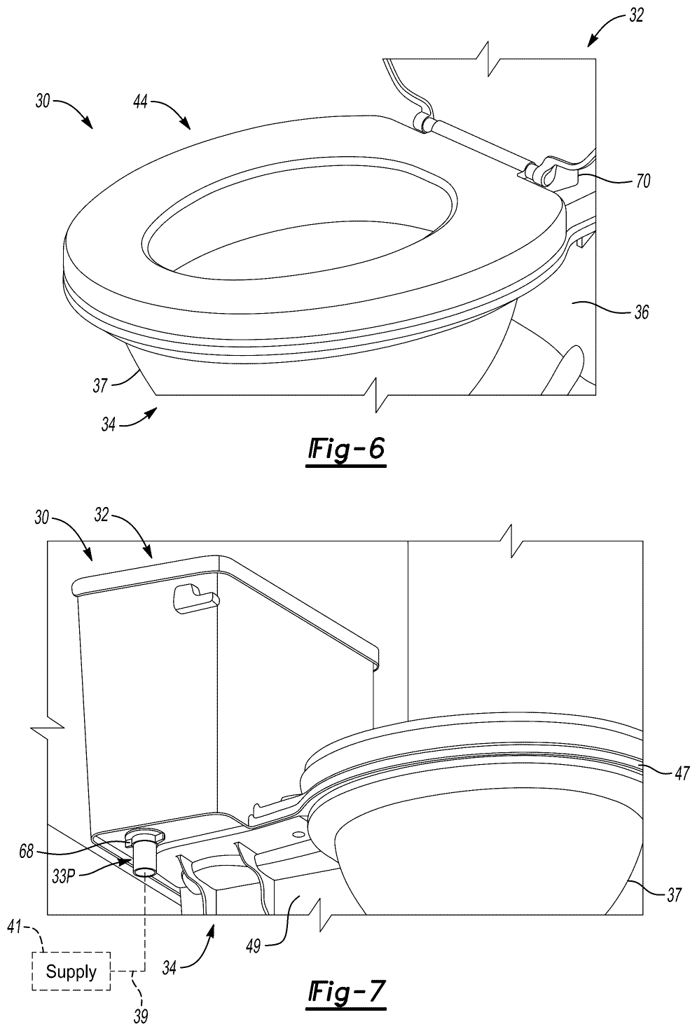

FIG. 6 discloses aspects of the toilet seat 44 and lid 56 of the toilet 30. The toilet seat 44 and lid 56 may include any of the materials and may be formed utilizing any of the techniques disclosed herein. The lid 56 may include one or more fixation members 70 (see also FIGS. 3-4). Each fixation member 70 may be adapted to capture or otherwise engage a respective mount (e.g., hinge) 72 of the toilet seat 44 (FIG. 3) to secure the lid 56 and the seat 44 to each other. In implementations, the fixation member 70 may establish a snap-fit connection with a respective hinge 72. The hinge 72 may be secured to the upper bowl 47 utilizing a fastener (e.g., bolt).

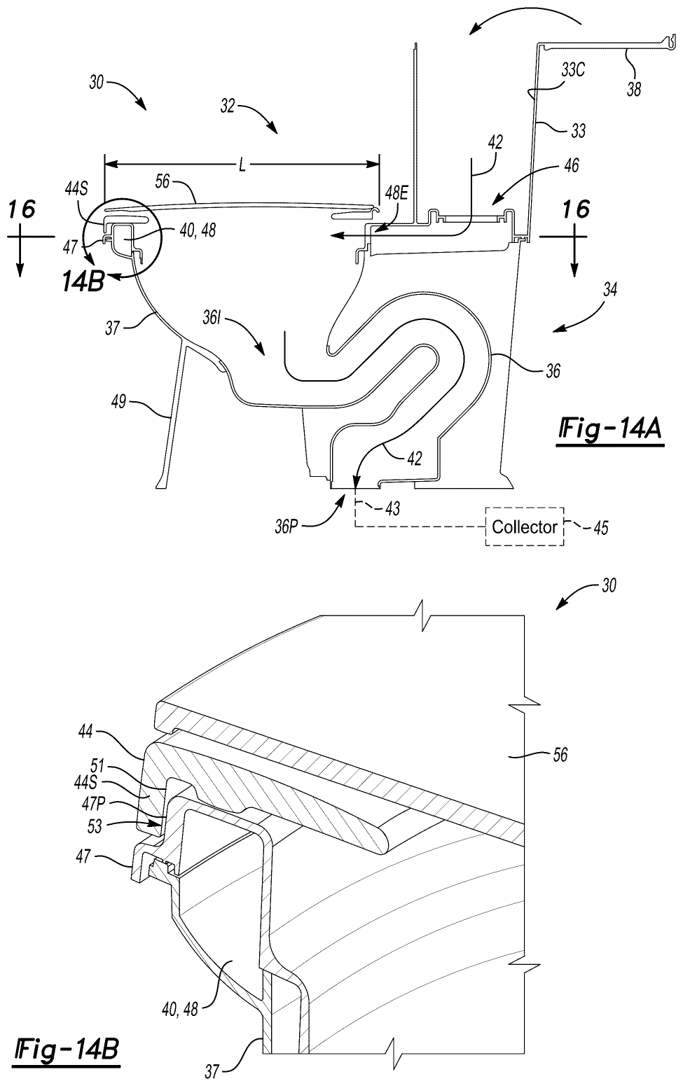

The toilet 30 may incorporate an interlock to reduce relative movement between the toilet seat 44 and the lower bowl 47. In the implementation of FIGS. 14A-14B, the toilet seat 44 may include a shoulder 44S. The lower bowl 47 may include an outer periphery 47P (see also FIG. 3). An inner periphery 51 of the shoulder 44S may be dimensioned to at least partially encircle and/or follow the outer periphery 47P of the lower bowl 47. The inner periphery 51 and outer periphery 47P may cooperate to establish an (e.g., interlocking) interface 53. The shoulder 44S may eliminate or otherwise reduce rotational motion of the seat 44 and may extend a life of the hinges 72.

FIG. 7 discloses a perspective view of aspects of the toilet 30. The toilet 30 may include one or more seals. The seal(s) may be configured to inhibit leakage of flow from the toilet 30. In implementations, the toilet 30 may include a (e.g., fill valve) tank seal 68, which may be the only seal of the toilet 30 excluding any seals incorporated into the components 37 in the cavity 33C of the tank. The tank 33 may include at least one port (e.g., inlet) 33P which may be adapted to be fluidly coupled to a supply line 39. The supply line 39 may be adapted to communicate (e.g., pressurized) fluid (e.g., water) from a supply 41 to the tank 33.

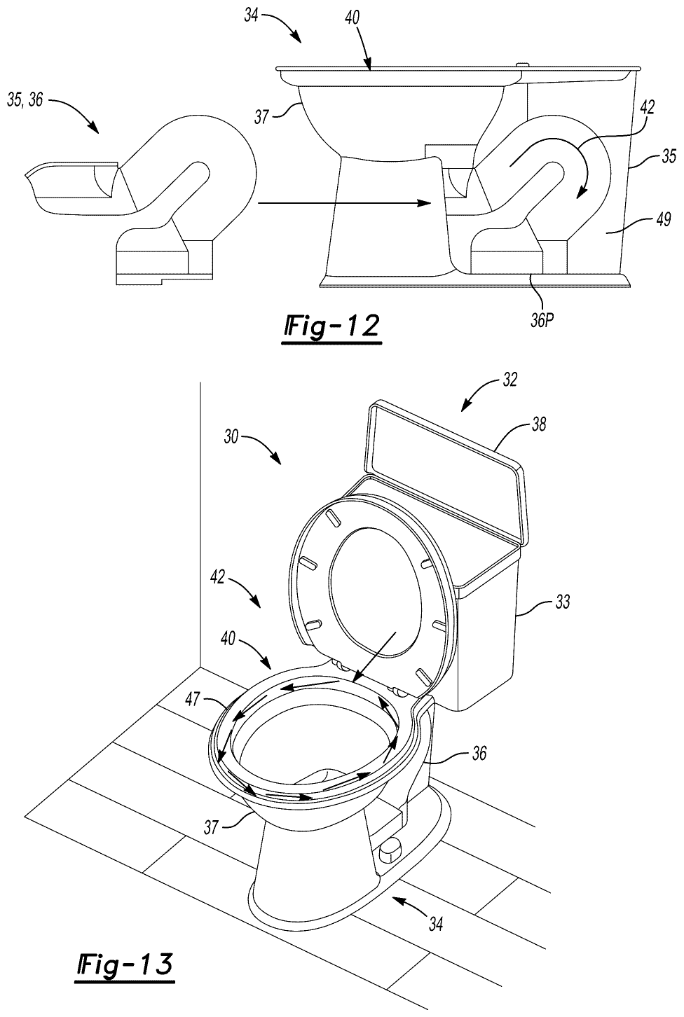

At least one flow path 42 may be established through the toilet 30, including through tank 33 and lower bowl 37. The trap 36 may establish a portion of the flow path 42 through the toilet 30 (e.g., FIG. 12). The trap 36 may include at least one port (e.g., outlet) 36P. In the implementation of FIG. 14A, the port 36P may be adapted to be fluidly coupled to a discharge (e.g., sewage or drain) line 43. The trap 36 may be adapted to interconnect the main bowl 37 and the discharge line 43. The discharge line 43 may be adapted to communicate waste from the trap 36 to a collector (e.g., sewage system) 45. The trap 36, lower bowl 37 and/or base 49 may be integrally formed or may be separate components fixedly attached or otherwise secured to each other. The trap 36 may be formed as a separate component 35 or may be incorporated into (e.g., formed with) the lower portion 34 as a single component 35.

Various materials may be utilized to fabricate or otherwise form the toilet 30 and its various components 35. The toilet 30 and/or component(s) 35 may be formed of various metallic and/or non-metallic materials, including any of the materials disclosed herein. Non-metallic materials may include various plastics such as thermoplastic polymers. Plastic resins including polyethylene (PE) and polypropylene (PP) may be utilized. Thermoplastic polymers may include a high-density polyethylene (HDPE) and/or polypropylene. HDPE and/or thermoplastic polymer materials may be impact resistant, durable and/or chemical resistant, and may be suitable for sanitary and/or medical applications. At least the tank 33 and/or upper bowl 47 of the upper portion 32, the trap 36, and/or the lower bowl 37 and/or base 49 of the lower portion 34 may be formed of a plastic material. At least 75 percent, or more narrowly at least 95 percent, of the materials of the toilet 30 may be non-metallic (e.g., plastic) excluding any fasteners, seals and components in the tank 33. In an implementation, all components of the toilet 30 may be non-metallic (e.g., plastic) excluding any fasteners, seals and components in the tank 33. The materials may include one or more additives. Additives may be incorporated into the materials to improve strength and/or lubricity. The additives may include talc or glass. The components 35 may include one or more coatings, such as silicon or a polytetrafluoroethylene (PTFE) (e.g., Teflon), which may improve flow along the flow path 42.

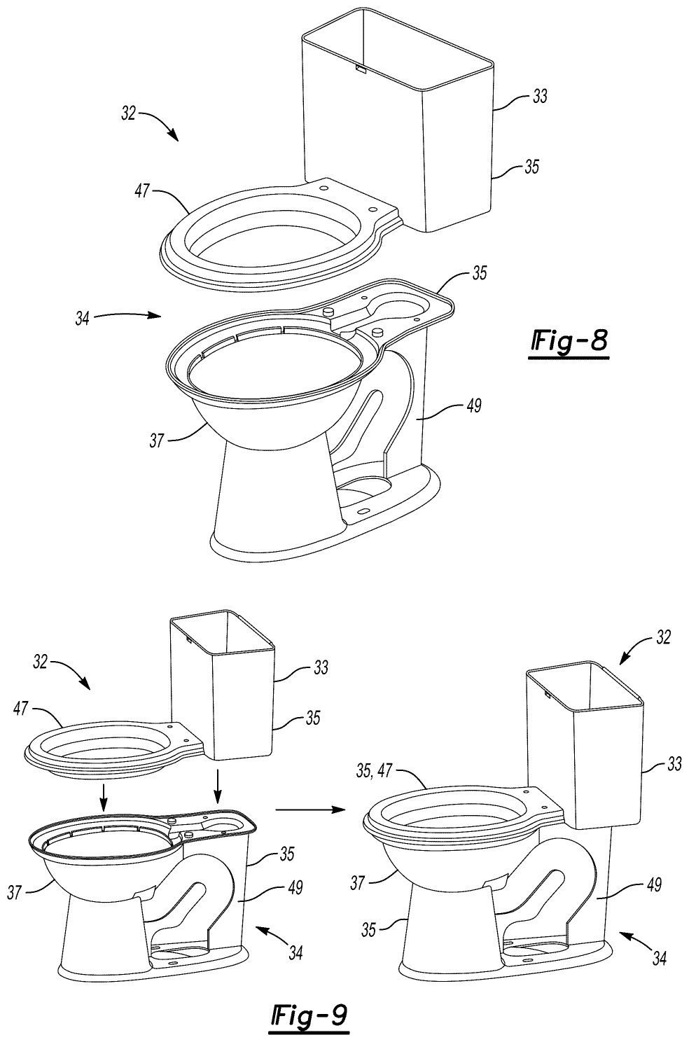

FIG. 9 discloses assembly of components 35 of the upper and lower portions 32, 34 of the toilet 30 according to an implementation. The upper and lower portions 32, 34 may be fixedly attached or otherwise secured to each other utilizing various techniques, including any of the techniques disclosed herein. The components 35 may include two or more sub-units which may be (e.g., releasably) secured to each other. The lower portion 32 and upper portion 34 may establish respective sub-units. The upper portion 32 and lower portion 34 may be joined together to form a unitary structure. In implementations, the upper and lower portions 32, 34 may be sonically welded to each other. The upper and lower portions 32, 34 may be (e.g., temporarily) secured to each other utilizing an epoxy (e.g., silicon) prior to the sonic welding. A sonic welding process may be used to fuse the lower bowl 37 and the upper bowl 47 to each other, which may establish a seal on the periphery and may form a flow (e.g., water) track 40. Sonic welding is a process that vibrates two pieces together at high speeds using friction to weld the plastics together. In other implementations, an adhesive such as silicone may be utilized to fixedly attach the upper and lower portions 32, 34 to each other.

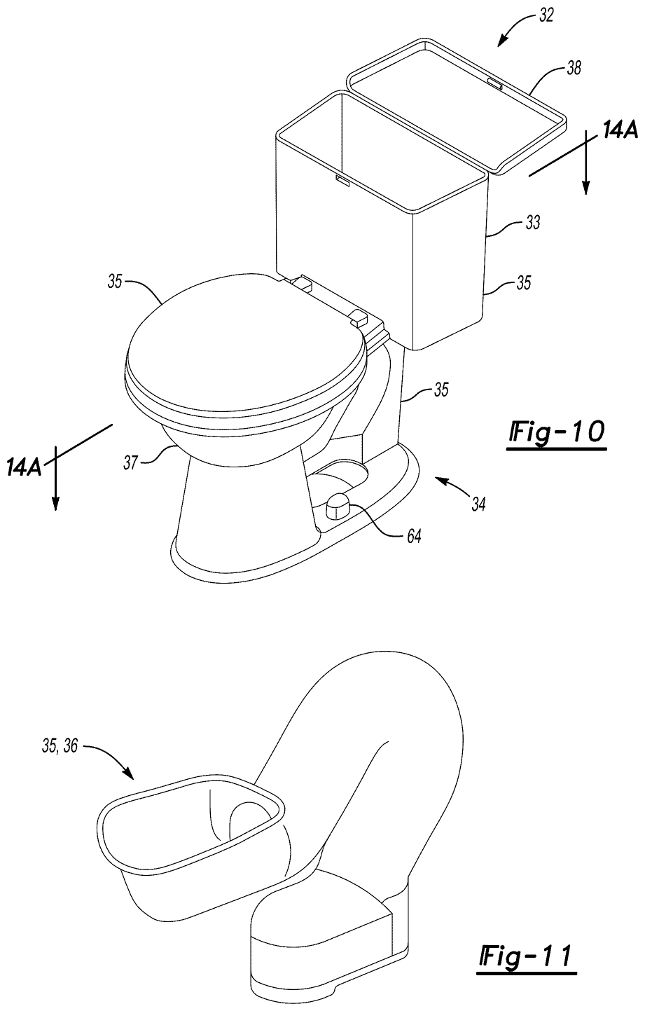

FIG. 10 discloses a perspective view of aspects of the upper portion 32 of the toilet 30, including components 35 of the toilet 30. FIG. 10 discloses the tank lid 38 in an open position and prior to arranging the trap 36 relative to the lower portion 34. FIG. 11 discloses an isolated, perspective view of the trap 36 according to an implementation.

FIG. 12 discloses a technique for arranging the trap 36 at least partially in a component 35 of the lower portion 34, such as the base 49, of the toilet 30 according to an implementation. In implementations, a component 35 of the lower portion 34 may be overmolded on the trap 36 to establish a single part. The trap 36 may be blow molded. The trap 36 may be overmolded to the lower portion 34. The trap 36 may be blow molded prior to being overmolded in the injection molding of the lower bowl 37. The trap 36 may be inserted or otherwise positioned in an injection mold during formation of the component 35. The trap 36 and lower portion 34 may be permanently fused together, establishing a unitary construction. The unitary construction may eliminate or otherwise reduce seals and/or leakage points which may be present in traditional toilets.

FIGS. 13-16 disclose the flow track 40 and associated flow path 42 according an implementation. At least one flow path 42 may be established through the toilet 30. The flow path 42 may be established through the tank 33 and/or bowl 37.

The flow track 40 may include various aspects, including a main entry point 46 which may be dimensioned to receive (e.g., water) flow from the tank 33, a channel 48 which may be established in the main bowl 37, and/or one or more slots (e.g., peripheral jets) 50 (e.g., FIG. 16). The slots 50 may be dimensioned to deliver flow of fluid (e.g., water) from the channel 48 to the main bowl 37. The channel 48 may be bounded by the upper bowl 47 and main bowl 37 (e.g., FIGS. 14A-14B). The channel 48 may extend at least partially about a periphery (e.g., rim) of the main bowl 37. In implementations, the channel 48 may extend at least 90 percent about the periphery of the main bowl 37 (e.g., FIG. 16). The lower portion 34 may include a wall (e.g., flap) 52 that may be dimensioned to separate an inlet (e.g., entrance) 48E of the channel 48 from a terminal end 48T of the channel 48. The slots 50 may be uniformly and/or non-uniformly distributed along a length of the channel 48.

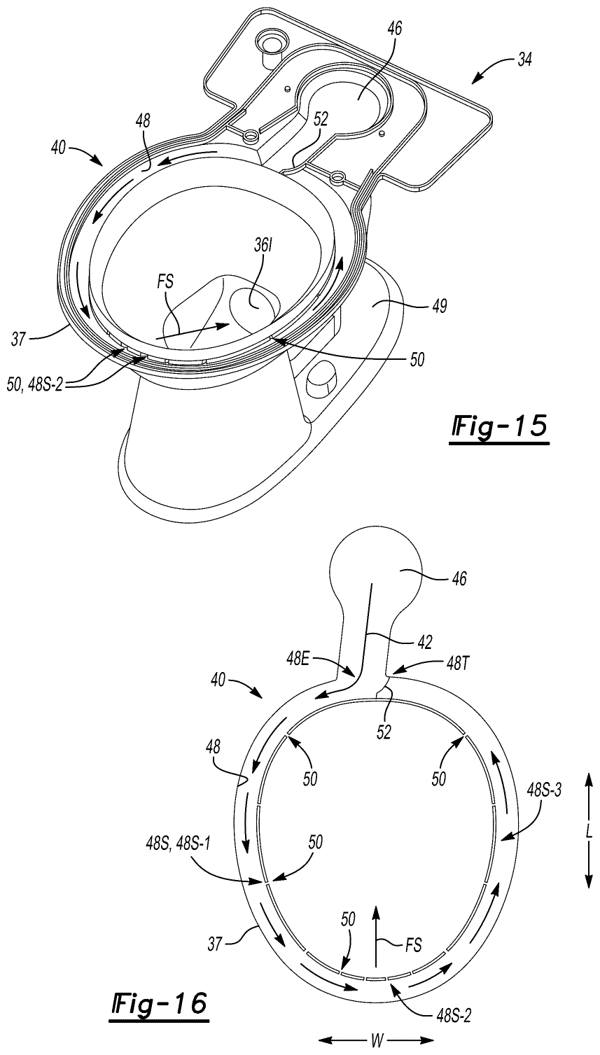

In the implementation of FIG. 16, the channel 48 may include two or more sections 48S having respective concentrations of the slots 50. The concentrations may be associated with a combined cross sectional area, which may be associated with a quantity and/or cross sectional area of the individual slots 50. Each section 48S may have at least one or more of the slots 50. The concentrations may be the same or may differ. The sections 48S may include first (e.g., upstream), second (e.g., intermediate) and/or third (e.g., downstream) sections 48S-1, 48S-2, 48S-3. The second section 48S-2 may be established between the first and third sections 48S-1, 48S-3. In implementations, the second section 48S-2 may have a greater concentration of the slots 50 than the first section 48S-1 and/or third section 48S-3. In implementations, the first section 48S-1 may be established adjacent to the entrance 48E of the channel 48. The third section 48S-3 may be established adjacent to the wall 52. The second section 52-2 may be axially aligned with an inlet port 361 of the trap 36 relative to a length L of the bowl 37, which may be greater than a width W of the bowl 37 (see also FIGS. 14A and 15). A relatively greater concentration of slots 50 along the second section 48S-2 of the channel 50 may provide a relatively high velocity fluid stream FS towards and/or through the trap 36. The flow track 40 may establish a relatively large volume fluid stream, which may improve velocity of the fluid through the bowl 37 and into the trap 36 to aid with flushing.

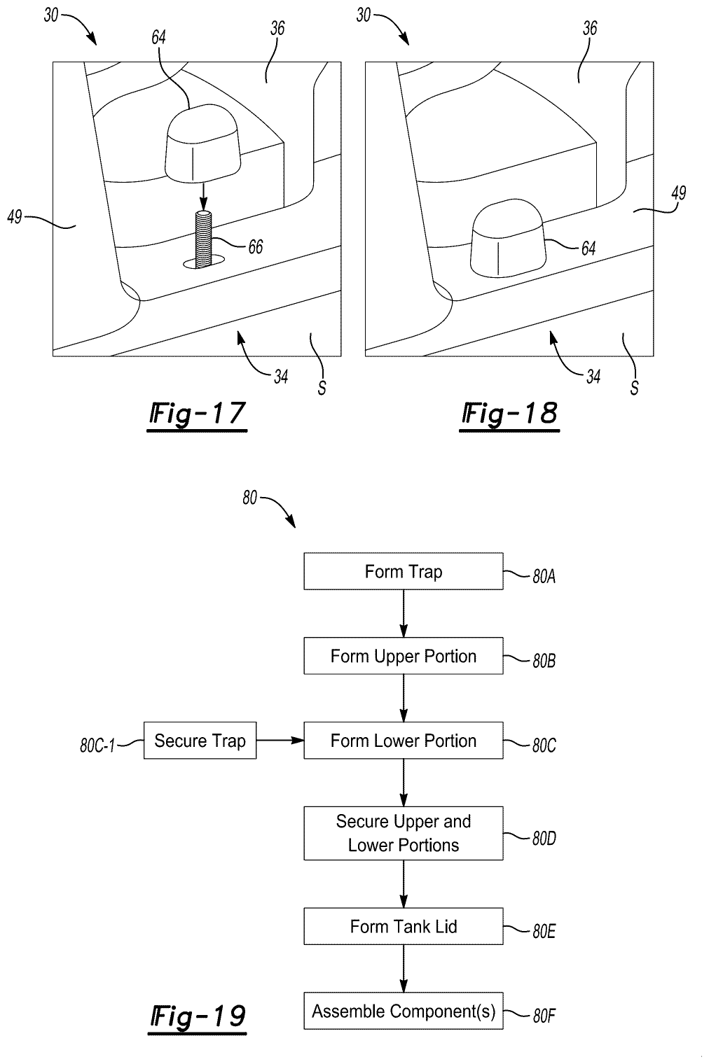

FIGS. 17-18 disclose the lower portion 34 of the toilet 30 and associated installation techniques according to an implementation. The lower portion 34 may be secured to a floor or other (e.g., static) structure S. The toilet 30 may include one or more components 35 adapted to secure the lower portion 34 to the structure S, such as one or more mounting caps 64. The mounting caps 64 may serve as tie-down nuts. The mounting caps 64 may adapted to mate with a respective mount such as a fastener (e.g., mounting stud or bolt) 66 to secure the lower portion 34 to the structure S. The mounting cap 64 may include a threaded bore adapted to mate with threading of the fastener 66. The fastener 66 may be securable to the floor or other structure. The mounting cap 64 may be formed of various materials, including any of the materials disclosed herein. In implementations, the mounting cap 64 may be formed by a non-metallic material. Forming the mounting cap 64 with a non-metallic material may avoid rusting due to exposure to moisture and/or the cap 64 detaching (e.g., popping off) from the respective fastener 66. The mounting cap 64 may be configured for hand tightening onto the fastener 66. The mounting cap 64 may be elongated for handling. The mounting cap 64 may eliminate or otherwise reduce the need for trimming a length of the respective fastener 66. The mounting cap 64 may be dimensioned to establish an interference fit, which may prevent or otherwise reduce a likelihood of backing off over the life span of the toilet 30.

FIG. 19 discloses a method of forming a toilet in a flowchart 80 according to an implementation. The method 80 may be utilized to form the toilet 30. Fewer or additional steps than are recited below could be performed within the scope of this disclosure, and the recited order of steps is not intended to limit this disclosure. Reference is made to the toilet 30.

At block 80A, a trap 36 may be formed. The trap 36 may be formed utilizing any of the techniques disclosed herein.

At block 80B, an upper portion 32 may be formed. The upper portion 32 may be formed utilizing any of the techniques disclosed herein. Block 80B may include injection molding the upper portion 32. Block 80B may include forming a first hinge portion 54A, which may be formed along a tank 33 of the upper portion 32.

At block 80C, a lower portion 34 may be formed. The lower portion 34 may be formed utilizing any of the techniques disclosed herein. Block 80C may include injection molding the lower portion 34. Block 80C may include securing the trap 36 and lower portion 34 to each other at block 80C-1. The trap 36 and lower portion 34 may be secured utilizing any of the techniques disclosed herein. Block 80C-1 may include overmolding the lower portion 34 on the trap 36. In other implementations, the trap 36 may be secured to the lower portion 34 after forming the lower portion 34 (e.g., by injection molding). In implementations, the trap 36 and lower portion 34 may be formed as a single component 35 (e.g., by injection molding).

At block 80D, the upper portion 32 and lower portion 34 may be secured to each other. The upper and lower portion 32, 34 may be secured utilized any of the techniques disclosed herein. The upper and lower portions 32, 34 may be secured to each other such that a flow path 42 is established through the upper portion 32, the lower portion 34 and the trap 36. Block 80D may include sonically welding the upper portion 32 and the lower portion 34 to each other to establish a unitary construction. The upper and lower portions 32, 34 may be (e.g., temporarily) secured to each other utilizing an epoxy (e.g., silicon) prior to the sonic welding. Block 80D may include sonically welding the lower bowl 37 and the upper bowl 47 to each other. Block 80D may occur such that a flow track 40 (e.g., FIGS. 14A-14B) may be established between the lower bowl 37 and the upper bowl 47.

Block 80E may include forming a tank lid 38. The tank lid 38 may be formed utilizing any of the techniques disclosed herein. Block 80E may include forming a raised periphery 38P and a recessed area 38R along an exterior (e.g., top) of the tank lid 38 (e.g., FIG. 1). The raised periphery 38P may bound the recessed area 38R. Block 80E may include forming a second hinge portion 54B of the tank lid 38.

Block 80F may include assembling one or more components 35, 37 of the toilet 30 to each other (e.g., FIGS. 3-4). The components 35, 37 may be assembled utilizing any of the techniques disclosed herein. Block 80F may include securing the first hinge portion 54A and the second hinge portion 54B to each other to establish a living hinge 54 such that the tank lid 38 and the tank 33 may be (e.g., pivotably) connected to each other (e.g., FIG. 5).

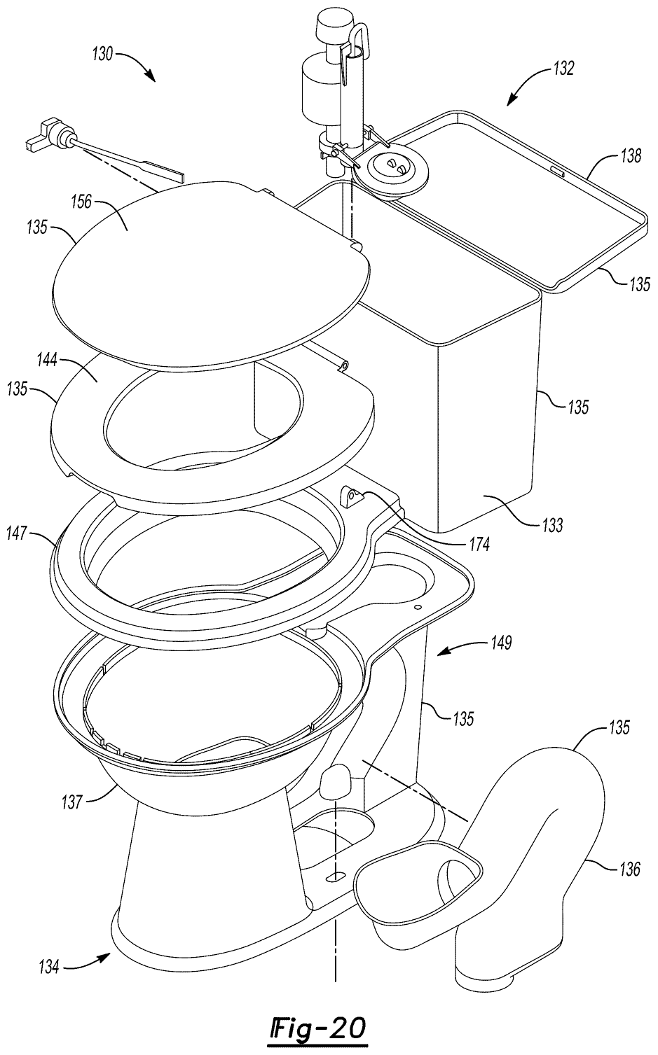

FIG. 20 discloses an exploded view of a toilet (e.g., unit or assembly) 130 according to another implementation. In this disclosure, like reference numerals designate like elements where appropriate and reference numerals with the addition of one-hundred or multiples thereof designate modified elements that are understood to incorporate the same features and benefits of the corresponding original elements. The toilet 130 includes one or more components 135, including any of the components disclosed herein. The toilet 130 may include an upper portion 132 and a lower portion 134. The upper and lower portions 132, 134 may be fixedly attached or otherwise secured to each other. The upper portion 132 may include a reservoir (e.g., tank) 133 and an upper bowl 147. The lower portion 134 may include a main (e.g., lower) bowl 137 and a base (e.g., support) 149. The toilet 130 may include a trap 136 (e.g., gooseneck).

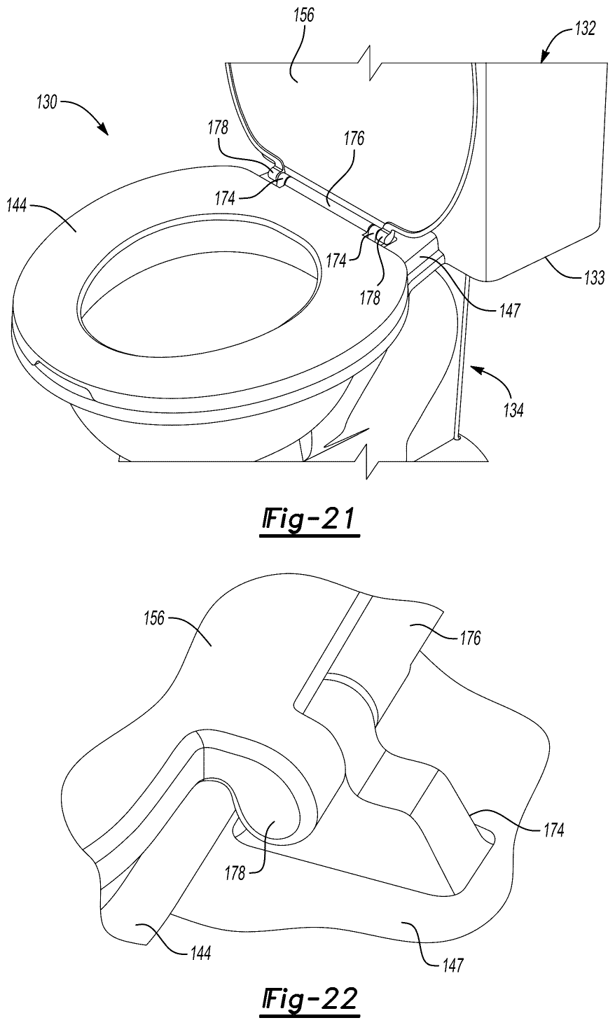

Referring to FIGS. 21-22, with continuing reference to FIG. 20, the toilet 130 may include a toilet seat 144 and/or a lid 156. Various techniques may be utilized to secure the toilet seat 144 and/or lid 156 to the upper bowl 147. The toilet 130 may include one or more mounting flanges (e.g., protrusions) 174. The toilet 130 may include a pair of mounting flanges 130 along the upper bowl 147. The mounting flanges 174 may be integrally formed with, or may otherwise be coupled to, the upper bowl 147. The toilet seat 144 may include an (e.g., elongated) support 176. The support 176 may be dimensioned to span between the mounting flanges 174. In other implementations, the support 176 may include a set of flanges. The lid 156 may include one or more interface flanges 178. The interface flanges 178 may be dimensioned to extend on opposite sides of the set of flanges 174. The mounting flanges 174 may be sandwiched between the support 176 and the respective interface flanges 178. The mounting flanges 174 and support 176 may cooperate to establish a first hinge connection. The mounting flanges 174 and interface flanges 178 may cooperate to establish a second hinge connection. The hinge connections may be established by protrusion(s) (e.g., detents) that mate with respective recesses. The arrangement of mounting flanges 174, support 176 and/or interface flanges 178 may avoid or otherwise reduce the need for separate fasteners and/or hinge caps.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A toilet comprising:
an upper portion including a tank and an upper bowl, wherein the tank includes at least one port adapted to be fluidly coupled to a supply line;
a trap; and
a lower portion secured to the upper portion, the lower portion including a lower bowl, and the lower portion overmolded on the trap;
wherein the trap is adapted to interconnect the lower bowl and a discharge line;
wherein a flow path is established through the tank, the lower bowl and the trap; and
wherein at least one of the upper portion and the lower portion is injection molded.

2. The toilet as recited in claim 1, wherein:
at least the tank of the upper portion is formed of a plastic material; and/or
at least the lower bowl of the lower portion is formed of a plastic material.

3. The toilet as recited in claim 2, wherein:
at least 75 percent of the materials of the toilet are non-metallic excluding any fasteners, seals and components in the tank.

4. The toilet as recited in claim 1, wherein:
the lower portion includes a flow track; and
the flow track includes a channel that extends at least partially about a periphery of the lower bowl.

5. The toilet as recited in claim 4, wherein:
the flow track includes a plurality of peripheral jets distributed along a length of the channel, and the peripheral jets are dimensioned to deliver flow from the channel to the lower bowl.

6. The toilet as recited in claim 5, wherein:
the peripheral jets are non-uniformly distributed along the length of the channel.

7. The toilet as recited in claim 6, wherein:
the channel includes an upstream section, and intermediate section and a downstream section, each of the upstream, intermediate and downstream sections comprising at least one of the peripheral jets, and the intermediate section has a relatively greater concentration of the peripheral jets than the upstream section and/or the downstream section.

8. The toilet as recited in claim 5, wherein:
the length of the channel extends at least 90 percent about the periphery of the lower bowl.

9. The toilet as recited in claim 1, further comprising:
a tank lid dimensioned to at least partially block access to a cavity of the tank;
wherein a living hinge interconnects the tank lid and the tank.

10. The toilet as recited in claim 9, wherein:
the living hinge includes a first hinge portion established by the tank lid and a second hinge portion established by the tank.

11. The toilet as recited in claim 9, wherein:
the tank lid includes a raised periphery and a recessed area along a top of the tank lid, and the raised periphery bounds the recessed area.

12. The toilet as recited in claim 1, further comprising:
one or more mounting caps comprising a non-metallic material and adapted to mate with a respective fastener to secure the lower portion to a floor.

13. The toilet as recited in claim 1, further comprising:
a toilet seat and a seat cover;
wherein the seat cover includes a fixation member that establishes a snap-fit connection with a mount of the toilet seat.

14. A method of forming a toilet comprising:
forming a trap;
injection molding a lower portion, wherein the lower portion includes a lower bowl;
injection molding an upper portion including a tank, wherein the tank is adapted to be fluidly coupled to a supply line; and
securing the upper portion and the lower portion to each other such that a flow path is established through the upper portion, the lower portion and the trap, and wherein the trap is adapted to interconnect the lower bowl and a discharge line.

15. The method as recited in claim 14, wherein:
the step of injection molding the lower portion includes overmolding the lower portion on the trap.

16. The method as recited in claim 14, wherein:
at least 75 percent of the materials of the toilet are plastic excluding any fasteners, seals and components in the tank.

17. The method as recited in claim 14, wherein:
the securing step includes sonically welding the upper portion and the lower portion to each other.

18. The method as recited in claim 14, wherein:
the lower portion includes a flow track, and the flow track includes a channel that extends at least partially about a periphery of the lower bowl; and
the flow track includes a plurality of peripheral jets distributed along a length of the channel, and the peripheral jets are dimensioned to deliver flow from the channel to the lower bowl.

19. The method as recited in claim 18, wherein the peripheral jets are non-uniformly distributed along the length of the channel.

20. The method as recited in claim 14, wherein the step of injection molding the upper portion includes forming a first hinge portion, and further comprising:
injection molding a tank lid, including forming a second hinge portion, and the tank lid is dimensioned to at least partially block access to a cavity of the tank; and
securing the first hinge portion and the second hinge portion to each other to establish a living hinge such that the tank lid and the tank are connected to each other.
